(19) United States
(12) Patent Application Publication
(10) Pub. No.: US 2010/0224667 A1
(43) Pub. Date: Sep. 9, 2010

(54) HAND-OPERATED DRIVE-IN POWER TOOL

(75) Inventors: Ulrich SCHIESTL, Feldkirch (AT); Klaus Bertsch, Frastanz (AT)

Correspondence Address: CROWELL & MORING LLP;INTELLECTUAL PROPERTY GROUP, P.O. BOX 14300, WASHINGTON, DC, 20044-4300, US

(73) Assignee: Hilti Aktiengesellschaft, Schaan (LI)

(21) Appl. No.: 12/716,931

(22) Filed: Mar. 3, 2010

(30) Foreign Application Priority Data
Mar. 6, 2009 (DE) 10 2009 001 371.7

(51) Int. Cl. B25F 5/00; B25C 1/06

(52) U.S. Cl. 227/156; 173/170

(57) ABSTRACT

A hand-operated drive-in power tool is disclosed. The tool includes a drive-in unit arranged in a housing and control electronics for controlling electrical device functions. At least one cooling element is arranged on the control electronics. The control electronics is furthermore cast with a casting compound, where the cooling element projects at least partially from the casting compound. In addition, the control electronics can be arranged on an end of the handle-side housing section facing away from the drive-in unit between the battery and the handle.

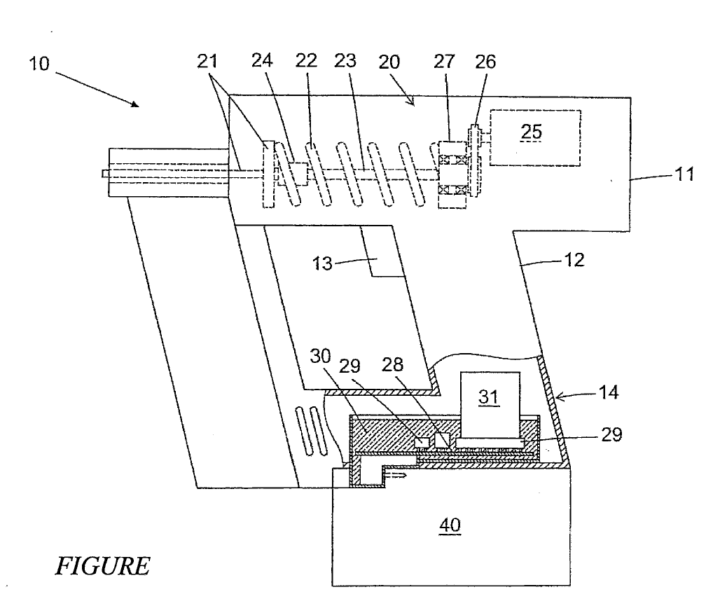

This application claims the priority of German Patent Document No. 10 2009 001 371.7, filed Mar. 6, 2009, the disclosure of which is expressly incorporated by reference herein.

### BACKGROUND AND SUMMARY OF THE INVENTION

The present invention relates to a drive-in power tool. These types of hand-operated drive-in power tools have a displaceably guided drive-in ram which can be used to drive the fastening elements into a workpiece.

In the case of a generic drive-in power tool known from WO 2007/142997 A2, a drive-in ram can be driven by a spring element. The spring element in this case can be transferred from a relaxed position to a tensioned position via a tensioning device that includes an electric motor. The spring element in this case serves as temporary storage for the mechanical energy supplied by the electric motor. If the drive-in power tool is triggered by pulling the trigger switch, then the spring element is uncoupled from the tensioning device and accelerates the drive-in ram, which can then drive a fastening element into a workpiece. The electric motor is activated by control electronics, which are located between the actual drive-in unit (tensioning mechanism with spindle, coupling, spring element and drive-in ram) and the handle.

The disadvantage of the known drive-in power tool is that the electronics that lie open in the device are directly exposed to the acceleration forces that are in effect when the drive-in power tool is in operation. In particular, larger and heavier electronic components or their contacts are therefore very much in danger of breaking.

The object of the present invention is developing a hand-operated drive-in power tool of the previously mentioned type, which is improved as compared to the known device and avoids the known disadvantages at least to some extent.

Accordingly, at least one cooling element is arranged on the control electronics. Furthermore, the control electronics are cast with a casting compound, wherein the cooling element projects at least partially from the casting compound.

Because of this measure, the control electronics can be protected effectively, on the one hand, from stress from impacts and accelerations and, on the other hand, an effective cooling of the control electronics is achieved.

15% to 90% of the axial extension of the cooling element is advantageously embedded in the casting compound perpendicular to the casting compound, thereby achieving both optimally coordinated shock resistance as well as optimum cooling of the electronics.

The casting compound is preferably formed by an elastic plastic material, thereby achieving a cost-effective but also effective shock absorbance. The casting compound in this case is advantageously made of a synthetic resin from the group of epoxy resins and polyurethane resins.

If the control electronics are arranged on an end of the handle-side housing section facing away from the drive-in unit between the battery and the handle, the handle can then be moved near to the drive-in axis, thereby minimizing the momentum that acts on the user's hand as a result of the device weight (center of gravity) and recoil during the drive-in process, something that is advantageous for the ergonomics of the device. In addition, the electronics in the case of the arrangement according to the invention are not exposed to such high accelerations, because the plastic of which the housing and thus the handle are made acts as a cushion. The service life of the control electronics can be increased considerably as a result.

It is advantageous if at least one cooling element is arranged on the control electronics, which lies in the axial projection of the handle and extends into the handle. This makes it possible to additionally achieve optimal cooling of the control electronics, because a chimney effect in the handle is used for heat dissipation on the cooling element.

### BRIEF DESCRIPTION OF THE DRAWING

The FIGURE illustrates a hand-operated drive-in power tool in accordance with the present invention in a partially longitudinal section of an exemplary embodiment.

### DETAILED DESCRIPTION OF THE DRAWING

The electric hand-operated drive-in power tool 10 has a housing 11, in which a drive-in unit designated as a whole by 20 is arranged (indicated in the FIGURE only with dashed lines). The drive-in unit 20 includes a drive-in ram 21, at least one drive spring 22, a tensioning element 23 embodied, for example, as a spindle for the drive spring 22, a coupling 24 between the drive-in ram 21 and the tensioning element 23, an electric motor 25, a transmission 26 for transmitting a tensioning motion of the electric motor 25 to the tensioning element 23 as well as a bearing 27 for the tensioning element 23.

A trigger switch 13 is arranged on a handle 12 of the drive-in power tool 10, which can be used to trigger a drive-in process. Control electronics 28 with various electronic components 29 in this case control the device's electrical functions, such as, for example, the function of the electric motor 25 and thus, among other things, also the tensioning of the drive spring element 22 via the electric motor 25. The control electronics 28 are arranged on an end of a handle-side housing section 14 facing away from the drive-in unit 20 and are arranged in this case between a detachably arranged battery 40 and the handle 12. The battery 40 in this case is used to supply the drive-in power tool 10 with electrical power. As an alternative to a battery, a power supply could also be arranged there so that the drive-in power tool 10 can be connected to the electricity network. The control electronics 28 are cast with a casting compound 30 made of an elastic plastic material, preferably of an epoxy or polyurethane resin, which protects the control electronics 28 against impacts and accelerations. In this case, at least one cooling element 31 is provided on the control electronics 28, which cools the control electronics 28. The cooling element 31 in this case projects from the casting compound 30 in a direction perpendicular to the surface of the casting compound to approx. 73.5% of its length in this direction (=axial extension) and extends into the handle 12.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A hand-operated drive-in power tool, comprising:
a housing;
a drive-in unit arranged in the housing and including control electronics for controlling electrical device functions; and
a cooling element arranged on the control electronics;
wherein the control electronics are cast with a casting compound and wherein a surface of the cooling element projects from the casting compound.

2. The hand-operated drive-in power tool according to claim 1, wherein 15% to 90% of an axial extension of the cooling element is embedded in the casting compound perpendicular to the casting compound.

3. The hand-operated drive-in power tool according to claim 1, wherein the casting compound is formed by an elastic plastic material.

4. The hand-operated drive-in power tool according to claim 1, wherein the casting compound is made of a synthetic resin from a group of epoxy resins and polyurethane resins.

5. A hand-operated drive-in power tool, comprising:
a housing including a housing section;
a drive-in unit arranged in the housing and including control electronics for controlling electrical device functions;
a handle embodied on the housing section of the housing; and
a battery arranged detachably on the housing section;
wherein the control electronics are arranged on an end of the housing section facing away from the drive-in unit and between the battery and the handle.

6. The hand-operated drive-in power tool according to claim 5, further comprising a cooling element arranged on the control electronics and which lies in an axial projection of the handle and extends into the handle.
